(19) United States
(12) Patent Application Publication
(10) Pub. No.: US 2019/0179838 A1
(43) Pub. Date: Jun. 13, 2019

(54) METHOD AND APPARATUS FOR PROVIDING BOOK RECOMMENDATION SERVICE

(71) Applicant: MIRAEN CO., LTD., Seoul (KR)

(72) Inventors: Hyeog-Chun KWON, Anyang-si (KR); Young-Hun JUNG, Yongin-si (KR); Jiwon HONG, Seongnam-si (KR); Junghoon PARK, Incheon (KR); Dughyun LEE, Goyang-si (KR)

(73) Assignee: MIRAEN CO., LTD., Seoul (KR)

(21) Appl. No.: 16/307,460

(22) PCT Filed: Jun. 5, 2017
(86) PCT No.: PCT/KR2017/005850

§ 371 Date: Dec. 5, 2018

(30) Foreign Application Priority Data
Jun. 7, 2016 (KR) 10-2016-0070325

(51) Int. Cl. G06F 16/335; G06F 17/27; G06Q 30/06; G09B 19/00

(52) U.S. Cl. CPC G06F 16/337; G09B 19/00; G06Q 30/0631; G06F 17/2765

(57) ABSTRACT

Provided are an apparatus and a method for providing a book recommendation service which receives information about a reader and possessing books from a user to recommend books suitable for the reader based on a keyword extracted from a recommended book by education area for the reader and a keyword obtained from the possessing books. According to the present invention, unlike a conventional method of recommending only books corresponding to an interest field of the user based on purchasing books of the user, keywords are extracted based on recommended books by education area according to an education course and then subdivided into a plurality of groups by age group or grade group based on personal information and possessing book information collected from a plurality of individuals and attributes of each group are set based on the personal information.

### CROSS-REFERENCE TO RELATED APPLICATIONS

This application is based on and claims the benefit of priority to Korean Patent Application No. 10-2016-0070325 filed on Jun. 7, 2016, with the Korean Intellectual Property Office, the disclosure of which is incorporated herein by reference.

### BACKGROUND OF THE INVENTION

### Field of the Invention

The present invention relates to an apparatus and a method for providing a book recommendation service, and more particularly, to an apparatus and a method for providing a book recommendation service which receives information about a reader and possessing books from a user to recommend a book suitable for the reader based on a keyword extracted from a recommended book by education area for the reader and a keyword obtained from the possessing books.

### Description of the Related Art

Currently, an online bookstore that sells books through the Internet may easily collect personal information about multiple users and purchase information based on a user's purchased book. Based on the collected information, the online bookstore recommends a book related to the user's interest or recommends a book suitable for the user based on purchased books of other users having the same interest as the user's interest.

As a result, the online bookstore supports the user to save a time required for searching books and provides various reviews related with the books provided from the online bookstore to enhance user's satisfaction for book selection.

However, since an existing book recommendation method applied to such an online bookstore is only to select an interest field based on the book purchased by the user and recommend a plurality of books purchased by a plurality of other users having properties similar to the user based on the selected interest field, the field of the recommended book is extremely limited or static, and thus there is a limit in recommending books in various fields to the user.

In particular, in the case of minors who need to cultivate knowledge in various fields, the existing book recommendation method has a problem in that it is difficult to support various books to be received because the books are recommended only for a specific field related to the interest of minors.

Further, since the existing book recommendation method has a structure which is difficult to determine a field required for cultivating knowledge without considering whether or not to completely read the purchased book of the user due to a limitation of specifying the interest field based on only the books purchased by the user, only the books in a specific related field are continuously recommended so that knowledge is specialized only in the specific field, and thus it is difficult to select various fields and support systematic learning development.

In addition, since the existing book recommendation method is difficult to determine whether or not to completely read the books purchased by the user, even if books which are not completely read but required for learning development of the user are included in the books purchased by the user, there is a problem in that the required books are not recommended and thus unnecessary books need to be additionally purchased.

### SUMMARY OF THE INVENTION

An object of the present invention is to increase user's satisfaction for recommended books while supporting balanced and systematic knowledge development of a reader through the recommended books by education area required for age group or grade group of the reader, by collecting information about possessing books and a reader as a subject reading the possessing books from the user, extracting main keywords based on recommended books by various education areas required for the reader, and then subdividing the main keywords by age group or grade group to recommend accurately to the user books by education area required for age group or grade group related with the possessing books of the user.

Another object of the present invention is to prevent unnecessary spending on purchasing books of the user by determining a completely read state by possessing books of the reader and recommending books which are not completely read by education area required for the reader among the possessing books based thereon.

According to an aspect of the present invention, there is provided an apparatus for providing a book recommendation service including: a collection unit which collects possessing book information about one or more possessing books for each individual and personal information about a reader of the possessing books to match and store the information; an extraction unit which extracts a plurality of main keywords by the education area by applying a weight to a redundancy frequency by keyword and each predetermined keyword based on recommended book information about each of one or more recommended books stored by predetermined education area; a grouping unit which groups the same personal information based on one or more predetermined attributes to generate a plurality of groups by the education area, extracts at least one of the plurality of main keywords based on the possessing book information corresponding to each group of the education area to include the extracted keyword in the group, and generates attribute information about the attribute based on the personal information belonging to the group to set the generated attribute information in the group; and a recommendation unit which selects the group having the most main keywords matched with the possessing book information of the user corresponding to recommendation request information when receiving the recommendation request information from a user apparatus, selects a group set with the same attribute information as the attribute information of the corresponding selection group by the education area, and searches possessing book information corresponding to the recommended book information and the recommendation request information based on the main keyword corresponding to the group selected by the education area to generate recommended book information about recommended books selected by the education area and then transmit the generated recommended book information to the user apparatus.

As an example related to the present invention, the grouping unit may select at least one of the plurality of main keywords according to the external output for each group corresponding to each education area to include the selected keyword in the group.

As an example related to the present invention, the grouping unit may compare personal information collected by the collection unit by one or more predetermined attributes with each other to group personal information having the same parameters by all attributes into each other and generate a plurality of groups by the education area, compare the possessing book information matched with each personal information belonging to a specific group among the plurality of groups with the main keyword to include at least one of the plurality of main keywords belonging to the education area corresponding to the specific group as the group keyword in the specific group, and set attribute information about attribute-specific parameters of the personal information belonging to the specific group as attributes of the group.

As an example related to the present invention, the grouping unit may extract a keyword having a redundancy frequency equal to or greater than a predetermined reference value which is calculated by comparison with each possessing book information corresponding to the specific group among the main keywords of the education area corresponding to the specific group as the group keyword to include the extracted keyword in the specific group.

As an example related to the present invention, the attribute may include at least one of age, gender, and area, and the grouping unit may set the attribute information about at least one of age, gender, and area as the group based on the plurality of personal information belonging to the group.

As an example related to the present invention, the recommendation unit compares attribute information set in the selection group with reader information about a reader as a book recommended target person corresponding to the recommendation request information by the attribute to change the attribute information of the selection group corresponding to the reader information based on the reader information when the attribute information is not matched with the reader information, generate individual-specific attribute information corresponding to the selection group and then select recommended books based on the individual-specific attribute information by the education area to generate the recommended book information.

As an example related to the present invention, the possessing book information may further include completely read book information about books completely read by the reader among the possessing books, the grouping unit may extract the main keyword based on the completely read book information included in the possessing book information, and the recommendation unit may select the selection group based on the completely read book information included in the possessing book information according to the recommendation request information.

As an example related to the present invention, the recommendation request information may further include state information about a layout state of bookshelves by possessing books and completely read books according to the possessing book information, and the recommendation unit may confirm a layout state of the recommended book information and the completely read book information based on the state information and transmit layout information for changing a layout position of the recommended book information to a layout position of the completely read book information or changing the layout position of the recommended book information to a predetermined position in the bookshelf to the user apparatus.

As an example related to the present invention, the recommendation unit may update attribute information of the group by the education area and at least one of main keywords included each group based on reader information and possessing book information corresponding to the recommendation request information in corporation with the grouping unit.

According to another aspect of the present invention, there is provided a method for providing a book recommendation service in an apparatus for providing a book recommendation service communicating with an user apparatus via a communication network, the method including: collecting possessing book information about one or more possessing books for each individual and personal information about a reader of the possessing books to match and store the information; extracting a plurality of main keywords by the education area by applying a weight to a redundancy frequency by keyword and each predetermined keyword based on recommended book information about each of one or more recommended books stored by predetermined education area; grouping the same personal information based on one or more predetermined attributes to generate a plurality of groups by the education area, extracting at least one of the plurality of main keywords based on the possessing book information corresponding to each group of the education area to include the extracted keyword in the group, and generating attribute information about the attribute based on the personal information belonging to the group to set the generated attribute information in the group; and selecting the group having the most main keywords matched with the possessing book information of the user corresponding to recommendation request information when receiving the recommendation request information from a user apparatus, selecting a group set with the same attribute information as the attribute information of the corresponding selection group by the education area, and searching possessing book information corresponding to the recommended book information and the recommendation request information based on the main keyword corresponding to the group selected by the education area to generate recommended book information about recommended books selected by the education area and then transmit the generated recommended book information to the user apparatus.

According to the present invention, unlike a conventional method of recommending only books corresponding to an interest field of the user based on purchasing books of the user, it is possible to support balanced and systematic knowledge acquisition through reading of recommended books by a plurality of education areas required for age group or grade group of the reader who is a recommendation target by extracting keywords based on recommended books by education area according to an education course and then subdividing the extracted keywords into a plurality of groups by age group or grade group based on personal information and possessing book information collected from a plurality of individuals, setting attributes of each group based on the personal information to recommend books to the user by various education areas required for knowledge development of a reader designated by the user based on the attributes of a group related with books possessed or completely read by the user requesting the recommended books.

Further, it is possible to increase satisfaction of the user and the reader on the recommended books by optimizing main keywords extracted from the plurality of books corresponding to the education area according to possessing books and attributes of the reader and determining an education progress state of the reader according to possessing books or completely read books of the reader as a book recommended person and reader's attributes such as age, gender, and area to accurately recommend books suitable for a current knowledge level of the reader.

Further, it is possible to prevent the user from unnecessarily additionally purchasing books and support the user to save the cost of purchasing the books by determining a completely read state by possessing books of the reader and selecting and recommending books which are required for the reader and not completely read by education area among the possessing books based on the determined state.

Further, it is possible to recommend optimized books suitable for the level of the reader as a book recommended target by customizing keywords for recommended books based on the reader designated by the user to support recommendation of books optimized for the reader and automatically rearranging and optimizing keywords for selection of recommended books according to a change in learning level depending on an education environmental change by tracking a change of the possessing books for each attribute such as age group, grade group, gender, and area according to an education environmental change.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram of a system for providing a book recommendation service according to an embodiment of the present invention;

FIG. 2 is a detailed configuration diagram of an apparatus for providing a book recommendation service based on the above-described configuration;

FIG. 3 is a schematic diagram for extracting main keywords by education area of the apparatus for providing a book recommendation service according to the embodiment of the present invention;

FIG. 4 is an exemplary diagram for a process of grouping keywords by education area considering personal possessed books of the apparatus for providing a book recommendation service according to the embodiment of the present invention;

FIGS. 5 to 7 are schematic diagrams for a process of recommending books of the apparatus for providing a book recommendation service according to the embodiment of the present invention;

FIG. 8 is an exemplary diagram for changing a bookcase layout for increasing reading efficiency of a recommended book according to the embodiment of the present invention; and

FIG. 9 is a flowchart of a method for providing a book recommendation service according to an embodiment of the present invention.

### DETAILED DESCRIPTION OF THE PREFERRED EMBODIMENT

Hereinafter, detailed embodiments of the present invention will be described with reference to the drawings.

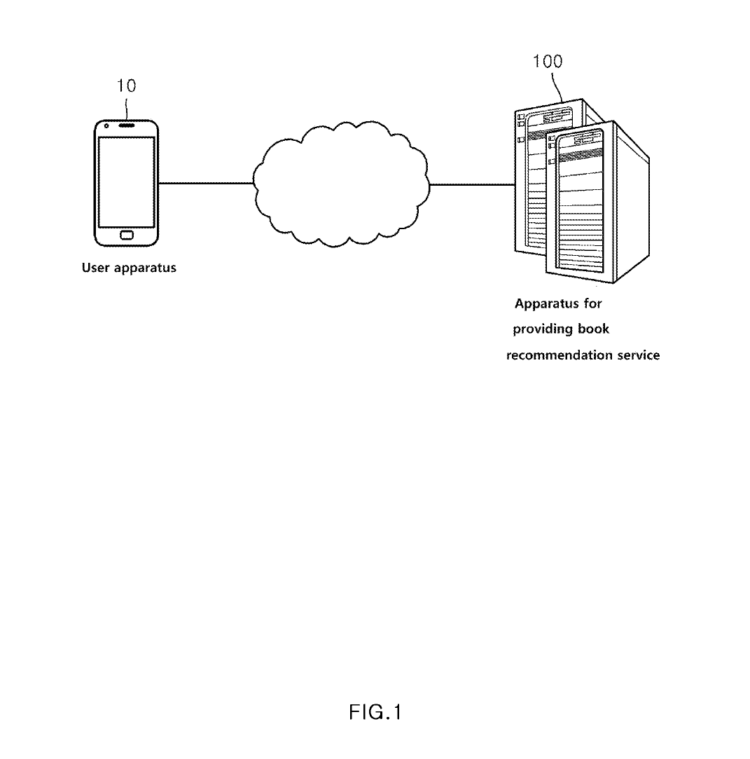

FIG. 1 is a configuration diagram of a system for providing a book recommendation service according to an embodiment of the present invention. As shown in FIG. 1, the system may include a user apparatus 10 which generates and transmits possessing book information about one or more possessing books and personal information about a reader as a subject who reads the possessing books based on a user input and an apparatus 100 for providing a book recommendation service which communicates with the user apparatus 10 through a communication network.

At this time, the reader may be the same as a user.

In addition, as the communication network, various known wired/wireless communication methods may be applied, and the user apparatus 10 may include various terminals such as a tablet PC, a laptop, a smart phone, a portable terminal, a mobile terminal, a personal digital assistant (PDA), a portable multimedia player (PMP) terminal, a personal computer, a wearable personal station (WPS), and the like, which have a communication function, an output function, and various interface functions.

The apparatus 100 for providing the book recommendation service may be configured as a server, and the apparatus 100 for providing the book recommendation service may collect possessing book information and personal information from a plurality of different user apparatuses 10 and collect recommended book information by a plurality of predetermined different education areas from external servers 200 by communicating with one or more predetermined different external servers 200 through the communication network.

At this time, the plurality of different education areas may be set to five areas (physical exercise/health, communication, social relations, art experience, and nature research) according to the Nuri Curriculum which is the standard education curriculum designated by the government or set to a plurality of different recommended book fields according to any one of elementary, secondary, and higher education courses.

Accordingly, the apparatus 100 for providing the book recommendation service collects recommended book information from the external server 200 corresponding to each education area, extracts main keywords from the recommended book information for each education area, and extracts and groups keywords related with possessing books for each age group or each grade group of the reader from the main keywords based on the personal information and the possessing book information collected from the plurality of users to subdivide keywords into a plurality of groups for each age group or each grade group with respect to one education area.

At this time, the apparatus 100 for providing the book recommendation service may extract and group main keywords related to one or more completely read books that are completely read by the user among the possessing books according to the possessing book information.

In addition, when the apparatus 100 for providing the book recommendation service receives a request for book recommendation from the user apparatus 10, the apparatus 100 may select a group of an education area to which a keyword having high relation with the possessing books of the user corresponding to the user apparatus 10 belongs, and determine an attribute for the identified group based on personal information about different individuals corresponding to the group selected by the selection.

Accordingly, the apparatus 100 for providing the book recommendation service may select recommended books for each education area suitable for the user by searching the recommended book information or searching the possessing book information of the user based on the main keywords included in the group by education area having the same attribute as the determined attribute in all education areas based on the attribute of the selected group, generate recommended book information about the recommended books, and then transmit the generated recommended book information to the user apparatus 10, thereby providing the recommended books required for the user to the user in other education areas as well as the education area related with the books possessed by the user.

Through the above-described configuration, the apparatus 100 for providing the book recommendation service extracts keywords based on the recommended books by education area according to an education course unlike an existing method of recommending only books corresponding to the interest field of the user based on the purchased book of the user and then subdivides the keywords into a plurality of groups for each age group or each grade group based on the personal information and the possessing book information and sets the attribute of each group based on the personal information to recommend to the user recommended books by other different education areas and books which are not completely read among the possessing books of the user based on attributes of groups related with the books which are possessed or completely read by the user requesting the recommended books. Therefore, it is possible to support the reader to achieve balanced and systematic knowledge acquisition by a plurality of education areas required for a specific age group or grade group of the reader as a recommended target through reading of the recommended books.

Hereinafter, a detailed operational configuration of the apparatus 100 for providing the book recommendation service will be described with reference to the following drawings based on the above-described configuration.

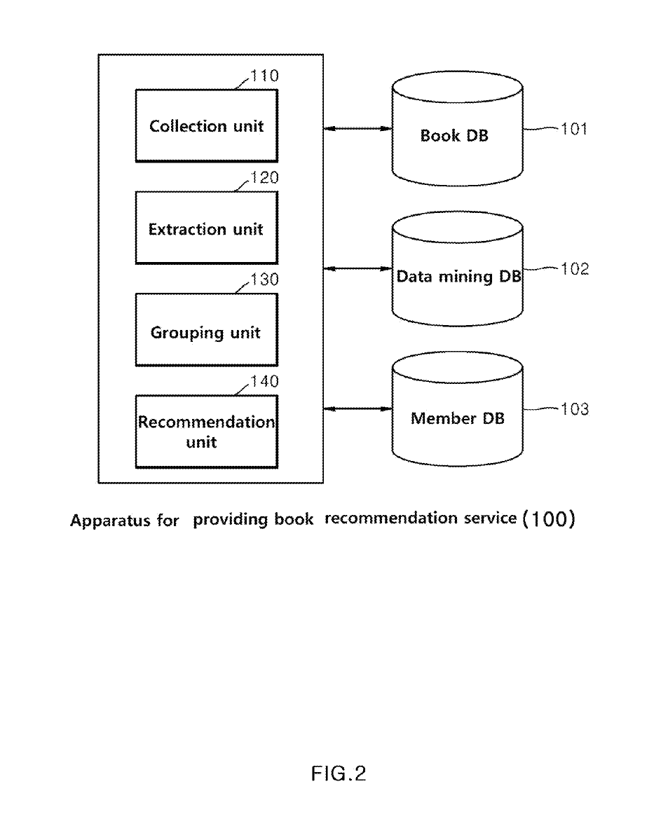

FIG. 2 is a detailed configuration diagram of the apparatus 100 for providing the book recommendation service based on the above-described configuration, and the apparatus 100 for providing the book recommendation service may include a collection unit 110, an extraction unit 120, a grouping unit 130 and a recommendation unit 140.

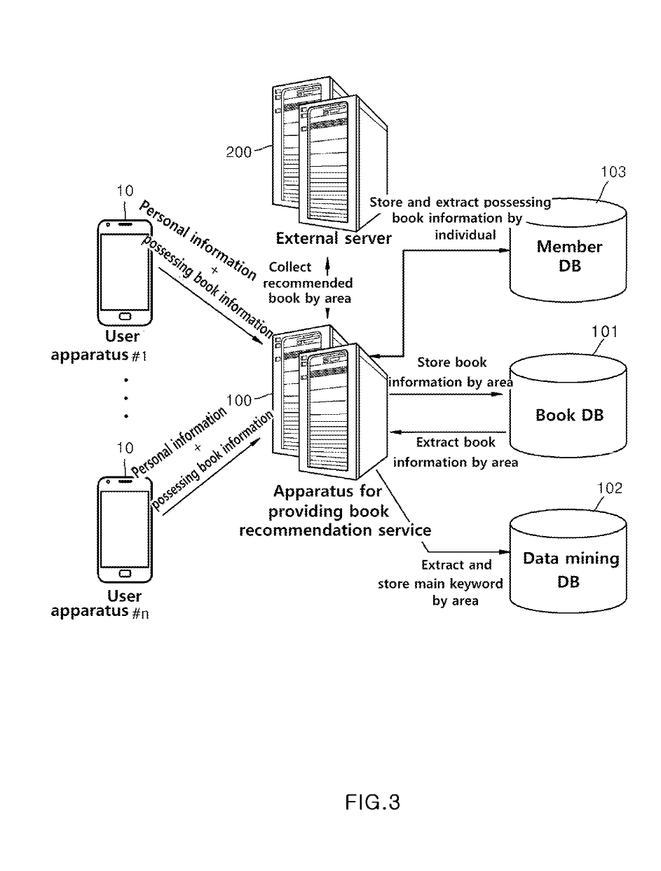

When describing the detailed configuration for each component of the apparatus 100 for providing the book recommendation service through the following drawing, first, as shown in FIG. 3, the collection unit 110 collects possessing book information for one or more possessing books possessed by the user and personal information about a reader reading the possessing books for each individual from the plurality of different user apparatuses 10 to match and store the personal information and the possessing book information in a member DB 103.

At this time, the possessing book information may include identification information such as a bar code, an international standard book number (ISBN) , a cover image, and the like for each of one or more possessing books possessed by the user, and may include completely read book information for one or more books which are completely read by the reader among the possessing books.

In addition, the identification information for each possessing book may include information about titles, authors, publishers, etc. of the possessing books.

In addition, the collection unit 110 may match user information about the user of the user apparatus 10 with the personal information and the possessing book information to store the information in the member DB 103, and receive continuously the possessing book information in real time to update the possessing book information stored in the member DB 103.

Also, the collection unit 110 may transmit education area information for each of the plurality of predetermined different education areas to the predetermined external server 200 and receive the recommended book information about the recommended books for each education area from the external server 200 to store the recommended book information in a book DB 101.

The extraction unit 120 extracts a plurality of main keywords having a redundancy frequency (appearance frequency) equal to or greater than a predetermined reference value for each education area based on a plurality of recommended book information received areas from the book DB 101 in response to the each education area and then match the extracted main keywords with education area information for the education area to store the matched education area information in a data mining DB 102.

At this time, the extraction unit 120 may apply a weight to predetermined different specific keywords and apply the weight to the redundancy frequency of the corresponding keywords to extract keywords having a redundancy frequency equal to or greater than a predetermined reference value as the main keywords. Here, the extraction unit 120 may set a weight designated according to an external input to a specific keyword selected according to an external input and apply the weight to the redundancy frequency of the corresponding keyword.

Accordingly, the apparatus 100 for providing the book recommendation service may extract and store main keywords having high relevance for each education area.

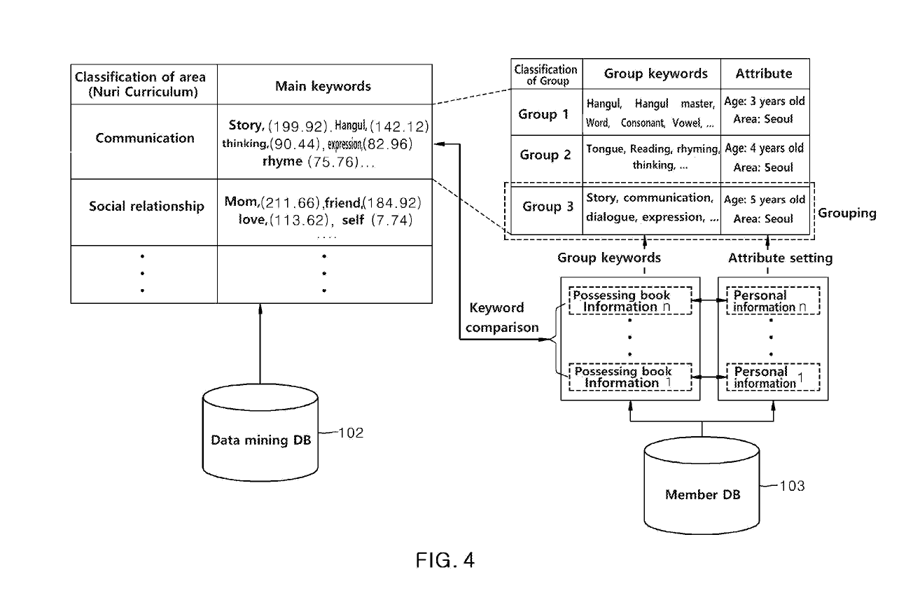

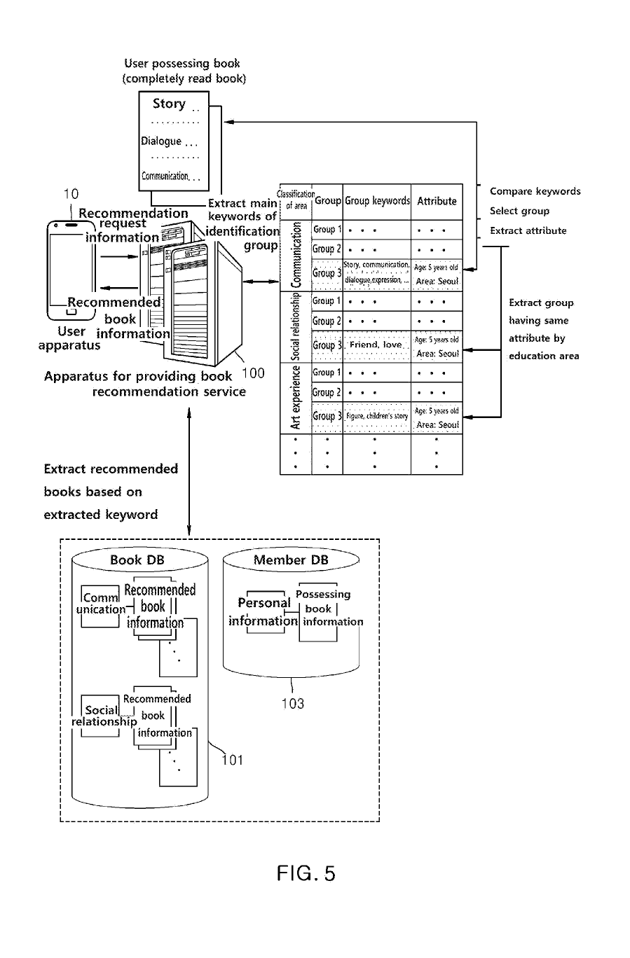

Meanwhile, the apparatus 100 for providing the book recommendation service operates to subdivide the main keywords into a plurality of groups by the area based on the possessing book information and the personal information collected from the plurality of user apparatuses 10 and then designates a personal attribute related with the books including the main keywords belonging to each group as an attribute of the group to recommend books optimized by identifying a group related with the reader designated by the user requesting the recommended books and considering attributes such as age, gender, and area of the reader, and the operation will be described in detail with reference to FIGS. 4 and 5 based on the aforementioned configuration.

FIG. 4 is a schematic diagram for a process of grouping keywords for each education area considering personal possessed books of the apparatus 100 for providing the book recommendation service according to the embodiment of the present invention. The grouping unit 130 may compare the personal information stored in the member DB 103 with each other by one or more predetermined attributes to group personal information in which all parameters (or data) by attribute are matched with each other into one group and as a result, group personal information that matches all the attributes to generate a plurality of different groups by the education area.

At this time, the attributes described in the present invention may include age, gender, area, and the like.

In addition, the grouping unit 130 may generate group information for each of the plurality of groups and match and store the generated group information with area information by education area stored in the data mining DB 102, respectively. At this time, the group information may include group identification information given by the grouping unit 130, education area identification information on an education area to which the group belongs, individual identification information on an individual belonging to the group, and the like.

Accordingly, the grouping unit 130 may match and store a plurality of groups grouped by individuals having the same attributes for each education area and divide groups by age group or grade group based on the personal information in response to each education area.

For example, as shown in FIG. 4, the grouping unit 130 may generate a plurality of groups and match (set) and store the plurality of groups for each of ‘communication’ and ‘social relationship’ which is one of the education areas.

Meanwhile, the grouping unit 130 generates attribute information based on parameters for each attribute of all the personal information belonging to the group by group of each education area sets the attribute information as the attribute information of the group to store the set attribute information in the data mining DB 102.

That is, the grouping unit 130 may set common parameters by personal attribute corresponding to the group by group of each education area as the attribute of the group to determine at least one of age, gender, and area common among the individuals in the group as the group attribute.

For example, as shown in FIG. 4, the grouping unit 130 may set a plurality of groups in response to ‘communication’, which is one of the education areas, and determine the age of ‘5 years old’ and the area of ‘Seoul’ corresponding to group 3 based on multiple personal information belonging to group 3 among the plurality of groups.

In this case, in the illustrated embodiment, the group is divided into three groups for convenience of explanation, but the group may be subdivided into a plurality of groups such as 10, 20, and 100 groups according to age, gender, area, and the like.

Meanwhile, the grouping unit 130 extracts possessing book information matched with each person information belonging to the specific group from the member DB 103 based on the group information stored in the data mining DB 102 with respect to a specific group in which attribute information is set, compares the extracted plurality of possessing book information with the plurality of main keywords stored in the data mining DB 102 corresponding to the education area to which the specific group belongs to calculate a redundancy frequency (appearance frequency) duplicated (appearing) with each main keyword in the extracted plurality of possessing book information, and then extract, as a group keyword, at least one keyword having the redundancy frequency (appearance frequency) equal to or greater than the predetermined reference value according to comparison with the extracted plurality of possessing book information among the plurality of main keywords corresponding (belonging) to the education area to which the specific group belongs and include the extracted keyword in the specific group.

At this time, the grouping unit 130 may include the group keyword in the group information corresponding to the specific group among the group information matched to the education area to which the specific group stored in the data mining DB 102 belongs.

In addition, the grouping unit 130 may set a weight for a specific keyword according to an external input when extracting the group keyword, and may apply the weight to the redundancy frequency (appearance frequency).

In addition, the grouping unit 130 may select at least one of the plurality of main keywords based on the external input and include the selected keyword as the group keyword in the specific group.

At this time, the grouping unit 130 transmits one or more identification information included in each of the plurality of possessing book information extracted from the member DB 103 or searches the book DB 101 in which the book information is stored to receive or extract contents for each of one or more possessing books included in the each possessing book information from the external server 200 or the book DB 101, and then matches the contents with each identification information of the possessing book information to include the contents in the possessing book information, and may compare a plurality of contents included in the plurality of possessing book information extracted from the member DB 103 with the plurality of main keywords to extract the group keyword.

The contents maybe e-book contents such as an electronic publication (EPUB) form, web information including titles, authors, publishers, tables of contents, plots, summaries, core keywords, tags, and the like for the possessing books, or preview data (e.g., summary information) for the possessing books.

In addition, after the user apparatus 10 transmits the identification information about the possessing books to the external server 200 and then receives the contents corresponding to the identification information from the external server 200 to generate possessing book information about the possessing books based on the corresponding contents and the identification information and then transmit the generated possessing book information to the apparatus 100 for providing the book recommendation service.

Meanwhile, as an example for the aforementioned configuration, the grouping unit 130 may extract, as a group keyword, keywords such as ‘story’, ‘communication’, ‘dialogue’, and ‘expression’ which have a redundancy frequency (appearance frequency) equal to or greater than a predetermined reference value according to comparison with the possessing book information among the plurality of main keywords corresponding to the education area for ‘communication’ and then group the keywords to be included in group 3. The main keyword belonging to the education area of the ‘communication’ such as ‘Hangul’, ‘word’, and ‘tongue’ having the redundancy frequency equal to or greater than a predetermined reference value in the plurality of possessing book information corresponding to the group 3 may not be included in the group 3, but may be included in groups other than the group 3.

At this time, the possessing book information may include completely read book information about each of one or more completely read books among the possessing books, and the grouping unit 130 compares the possessing book information based on the completely read book information to extract the group keyword.

In addition, the grouping unit 130 may match the group information including the main keywords of the group generated in correspondence with the education area and the attribute information set in correspondence with the group information, with the area information stored in the data mining DB 102 to store the matched information in the data mining DB 102.

As described above, the grouping unit 130 compares personal information collected by the collection unit 110 by one or more predetermined attributes with each other to group personal information having the same parameters by all attributes into each other and generate a plurality of groups by the education area, compares the possessing book information matched with each personal information belonging to the specific group among the plurality of groups with the main keyword to include at least one of the plurality of main keywords belonging to the education area corresponding to the specific group as the group keyword in the specific group, and sets attribute information about parameters for each attribute of the personal information belonging to the specific group to generate group information and attribute information for each group belonging to each education area.

Through the above-described configuration, the apparatus 100 for providing the book recommendation service may group main keywords associated with the readers belonging to the group according to a plurality of groups grouping readers whose attributes match the main keywords extracted according to the education area.

Meanwhile, the apparatus 100 for providing the book recommendation service automatically determines attributes such as age, gender, and area of a reader which is a subject reading the recommended books based on the possessing books of the user when the user requests the recommended books and supports the book optimized for the reader who is a book recommendation target to be recommended to the user for each education area based on the determined attributes, which will be described in detail with reference to FIG. 5.

FIG. 5 is a schematic diagram for a process of recommending books of the apparatus 100 for providing the book recommendation service according to the embodiment of the present invention, and the recommendation unit 140 of the apparatus 100 for providing the book recommendation service shown in FIG. 2 may receive recommendation request information including possessing book information from the user apparatus 10 requesting the book recommendation.

At this time, the recommendation unit 140 may receive the recommendation request information through the collection unit 110.

In addition, the recommendation unit 140 may compare the possessing book information included in the recommendation request information with the keyword of each group according to each group information matched and stored for each education area in the data mining DB 102, select a group of a specific education area having the largest number of main keywords matched with the possessing books included in the possessing book information, and extract attribution information of the corresponding selected group.

For example, the recommendation unit 140 may select ‘group 3’ matched with the education area corresponding to ‘communication’ based on the possessing book information and extract attribute information set in the ‘group 3’ as the selection group from the data mining DB 102.

In addition, the recommendation unit 140 may extract a group keyword from the group information corresponding to the extracted attribution information. In addition, the recommendation unit 140 may select a group in which attribute information matched (identical) with the attribute information is set in each of education areas other than the education area to which the group corresponding to the extracted attribute information belongs and extract a group keyword from the data mining DB 102 by education area from the group information corresponding to the group selected from the different education areas.

Accordingly, the recommendation unit 140 may automatically determine the attributes of a book recommended person related to the user based on the possessing books of the user who has requested the recommended book and extract keywords for each education area related to the attribute of the book recommended person based on the group information.

That is, the recommendation unit 140 may extract, for each education area, a group keyword of a group that coincides with the attribute of the reader determined based on the possessing books of the user with respect to all the education areas.

Accordingly, the recommendation unit 140 may search recommended book information of the book DB 101 based on the group keyword included in the group information corresponding to the selection group selected by education area in response to the extracted attributed information, search the possessing book information stored in the member DB 103 in correspondence with the possessing book information included in the recommendation request information or the personal information of the user included in the recommendation request information based on the group keyword by the education area to select (extract) recommended books by education area from at least one of the recommended book information and the possessing book information, generate recommended book information about the recommended books selected by the education area, and transmit the corresponding recommended book information to the user apparatus 10.

At this time, the recommendation unit 140 may select a recommended book corresponding to the group keyword of the book information about other books except for the completely read books corresponding to the completely read book information in the possessing book information to include the selected recommended book in the recommended book information, and if the recommended book selected from the recommended book information is the completely read book, the book may be excluded from the recommended book information.

In addition, the recommendation unit 140 may compare all the group keywords included in the selection group with at least one of the recommended book information and the possessing book information with respect to any one specific education area to select books including all the group keywords in the specific education area and having a redundancy frequency (appearance frequency) of the keyword duplicated with each group keyword equal to or greater than a predetermined reference value as the recommended book from at least one of the recommended book information and the possessing book information and generate recommended book information about the selected recommended book corresponding to each of all the education areas.

In addition, the recommendation unit 140 may include at least one of the contents and the identification information corresponding to each recommendation book in the recommended book information.

Accordingly, the recommendation unit 140 may generate recommendation book information by matching the area information about each education area with the identification information about each of one or more recommended books corresponding to each education area and then transmit the corresponding recommendation book information to the user apparatus 10.

As described above, the apparatus 100 for providing the book recommendation service subdivides the main keywords extracted from the plurality of books corresponding to the education area according to the attributes of the reader to accurately recommend a book having high relevance to the book recommended person considering the attribute of the book recommended person corresponding to the book recommendation request of the user, thereby increasing the user's satisfaction with the recommended book.

In addition to the above-described configuration, the recommendation unit 140 of the apparatus 100 for providing the book recommendation service may identify one or more education areas to which each book possessing book belongs according to the possessing book information based on the possessing book information included in the recommendation request information and calculate distribution for each education area for the distribution of possessing books by educational area.

Accordingly, the recommendation unit 140 may generate recommended book information by selecting the recommended book only for the education area having the distribution by education area equal to or greater than a predetermined reference value, or may generate recommended book information by controlling the number of recommended books by the education area according to the distribution by education area. Through this, it is possible to support even knowledge cultivation of a reader (a book recommended target person) corresponding to the recommendation request information by selecting intensively recommended books in an education area having a relatively low distribution.

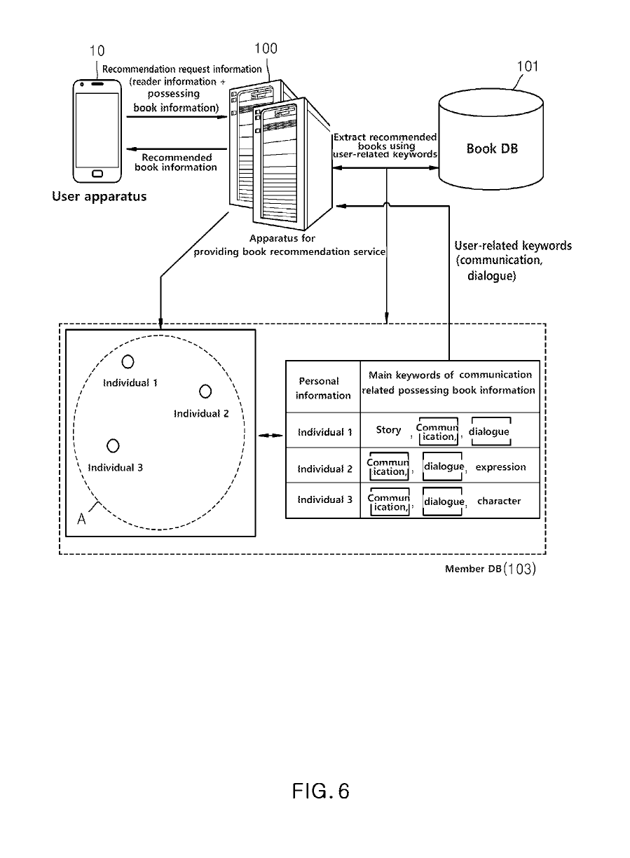

On the other hand, the apparatus 100 for providing the book recommendation service selects and recommends recommended books based on books possessed by a plurality of individuals having attributes similar to the attributes of the reader designated by the user when recommending the books to recommend more optimized books to the reader, which will be described in detail with reference to FIG. 6 based on the aforementioned configuration.

As shown in FIG. 6, the user apparatus 10 may further include reader information about a reader as a book recommended target person designated by the user in the recommendation request information to transmit the reader information to the apparatus 100 for providing the book recommendation service.

At this time, the possessing book information and the reader book included in the recommendation request information are prestored in the member DB 103 and may not be included in the recommendation request information. In addition, the recommendation unit 140 of the apparatus 100 for providing the book recommendation service may receive the book recommendation service including the user information about the user corresponding to the user apparatus 10, extract possessing book information and reader book corresponding to the recommendation request information from the member DB 103 based on the user information included in the recommendation request information, and include the extracted possessing book information and reader book in the recommendation request information.

In addition, the reader information described in the present invention may refer to personal information collected by the collection unit 110.

Meanwhile, the recommendation unit 140 of the apparatus 100 for providing the book recommendation service may search personal information belonging to each group in the member DB 103 based on one or more group information stored in the data mining DB 102 by education area, compares the predetermined attribute-specific parameters of the reader information included in the recommendation request information received from the user apparatus 10 with the personal information, select personal information including attribute-specific parameters matched with all the attribute-specific parameters of the reader information and group information to which the personal information belongs, and extract possessing book information matched and stored in the selected personal information from the member DB 103.

At this time, the reader information included in the recommendation request information may be information on a reader reading the recommended book according to the recommendation request information, and the reader according to the reader information may be the same as or different from the user.

For example, as shown in FIG. 6, the recommendation unit 140 may select as main personal information personal information corresponding to each of individual 1 to individual 3 of a specific group (A) in which parameters by attribute for each of age, gender, and area according to the reader information are matched in response to a specific education area and extract possessing book information possessed by individual 1 to individual 3 matched and stored in the main person information.

Through this, when the grouping unit 130 groups the keywords based only on the attributes of the age and the area of the individual, the recommendation unit 140 may extract personal information in which the attribute-specific parameters are matched with the reader in response in a specific group by further considering the gender as well as the age and the area.

According to the above-described configuration, the recommendation unit 140 may extract, from the member DB 103, personal information in which all the attribute-specific parameters set in correspondence with the reader corresponding to the recommendation request information by different education areas are matched, compare the personal information extracted in correspondence with the recommendation request information from the member DB 103 with the data mining DB 102 as the main personal information to select a specific group of the education area to which the main personal information belongs by education area, and extract the group information corresponding to the selected group by education area.

Further, the recommendation unit 140 may extract possessing book information matched with each of one or more main personal information extracted from the member DB 103 and then compare a group keyword included in the group information by education area with a plurality of possessing book information extracted in correspondence with the attribute of the reader information to extract one or more user related keywords having a predetermined reference level or more of redundancy frequency (or an appearance frequency appearing in the possessing book information) duplicated in the possessing book information among a plurality of group keywords included in the group information by education area from the data mining DB 102.

At this time, the recommendation unit 140 may extract completely read book information from each possessing book information extracted from the member DB 103 and compare the group keyword with the completely read book information to extract the user related keyword.

Thereafter, the recommendation unit 140 may compare the user-related keyword extracted for each education area with the recommended book information and the possessing book information included in the recommendation request information by education area to extract (select) one or more recommended books which include all user-related keywords in correspondence with each education area and have a redundancy frequency (appearance frequency) of each user-related keyword equal to or greater than a predetermined reference value from the recommended book information and the possessing book information by education area and generate recommended book information to transmit the recommended book information to the user apparatus 10.

At this time, the recommendation unit 140 may extract the recommended books from the remaining books except for the completely read books among the possessing books according to the possessing book information.

Through the above-described configuration, the apparatus 100 for providing the book recommendation service may select recommended books based on keywords related with possessing books or completely read books preferred by a plurality of other users having the same attributes as the reader designated by the user to recommend the books to the user, thereby recommending optimized books to the reader designate by the user.

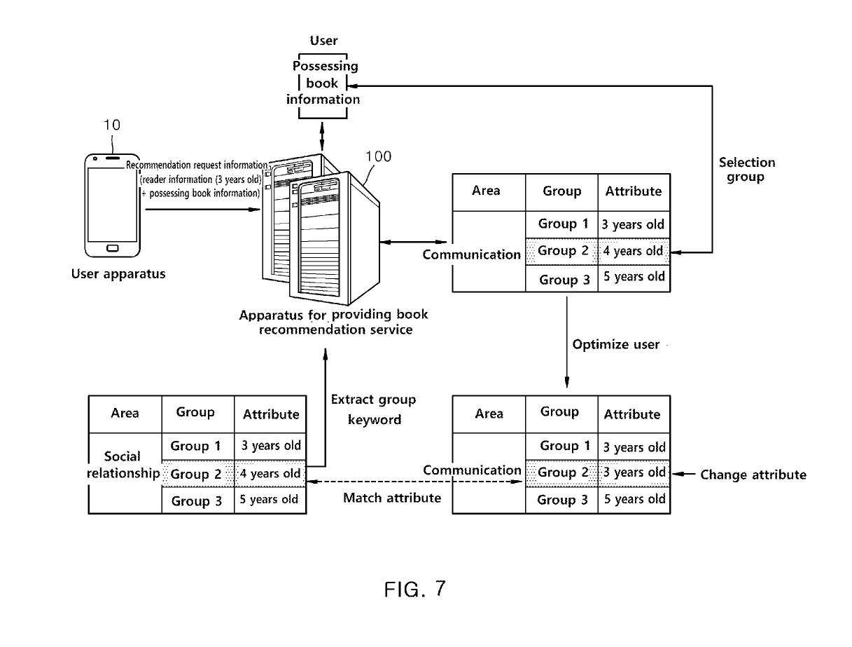

Meanwhile, the apparatus 100 for providing the book recommendation service may vary the attributes of the groups subdivided by the education area so as to recommend books suitable for the level of the reader designated by the user according to the level of the reader, which will be described with reference to FIG. 7.

As shown in FIG. 6, the recommendation unit 140 of the apparatus 100 for providing the book recommendation service may compare group keywords by group information corresponding to any one education area with possessing book information included in the recommendation request information received from the user apparatus 10 to select group information having the most group keywords matched with the possessing book information as a selection group, change and update attribute-specific parameters which are not matched with the attribute-specific parameters according to the reader information in the attribute information set in the corresponding selection group based on the attribute information of the reader information, and generate attribute information updated based on the reader information corresponding to the selection group as individual-specific attribute information to match and store the generated attribute information with the personal information corresponding to the recommendation request information in the member DB 103. At this time, the recommendation unit 140 may match group information about the selection group corresponding to the individual-specific attribute information with the individual-specific attribute information to store the matched group information in the member DB 103.

In addition, the recommendation unit 140 may determine whether there is individual-specific attribute information related to the user corresponding to the recommendation request information in the member DB 103 when selecting recommended books by education area corresponding to the recommendation request information, and select the recommended books by the education area using the individual-specific attribute information instead of the attribute information set in the selection group when there is the individual-specific attribute information recommendation book information to generate recommended book information.

In addition, the recommendation unit 140 may identify personal information corresponding to the recommendation request information in the member DB 103 when receiving the recommendation request information from the user apparatus 10 after the individual-specific attribute information is stored, and determine whether there are group information and attribute information matched and stored in the personal information to generate the recommended book information using the group information and attribute information stored in the member DB 103 when there are the group information and the attribute information and then transmit the recommended book information to the user apparatus 10.

Meanwhile, the recommendation unit 140 may collect and compare the group information and the individual-specific attribute information matched with the person information of different individuals stored in the member DB 103 in cooperation with the grouping unit 130 to calculate attribute-specific parameters having a high redundancy frequency by group for each education area as an update parameter, and update group-specific attribute information according the group information by education area stored in the data mining DB 102 based on the update parameter.

In addition, the recommendation unit 140 may continuously update or accumulatively store personal information and possessing book information corresponding to the recommendation request information in the member DB 103 based on the reader information and the possessing book information included in the recommendation request information and continuously update at least one of group information (group keyword) and attribute information by the education area based on the accumulated or updated information of the member DB 103 periodically or in real time in cooperation with the grouping unit 103 through the aforementioned configuration.

Accordingly, the apparatus 100 for providing the book recommendation service may customize keywords for recommended books based on the reader designated by the user to support recommendation of books optimized for the reader and automatically rearrange and optimize keywords for selection of recommended books according to a change in learning level depending on an education environmental change by tracking a change of the possessing books for each attribute such as age group, grade group, gender, and area according to an education environmental change to recommend the optimized books suitable for the level of the reader as a book recommendation target.

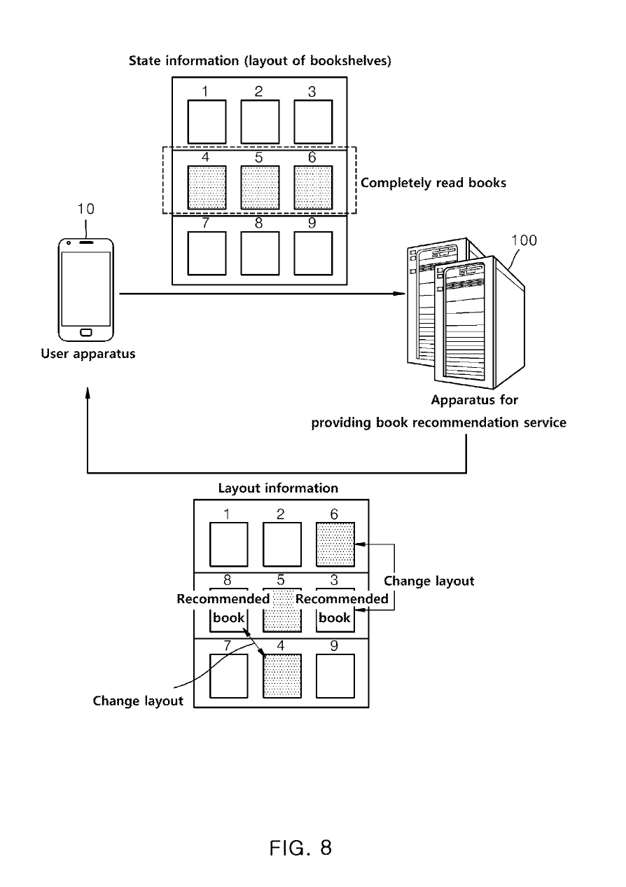

Meanwhile, the apparatus 100 for providing the book recommendation service may be provided to increase reading efficiency of the recommended books when recommending the books, which will be described in detail with reference to FIG. 8.

As shown in FIG. 8, the user apparatus 10 may include state information about the layout of bookshelves by possessing books and completely read books included in the possessing book information in the recommendation request information to transmit the state information to the apparatus 100 for providing the book recommendation service.

Accordingly, when the recommended book information is generated from the possessing book information included in the recommendation request information, the recommendation unit 140 of the apparatus 100 for providing the book recommendation service may determine a bookshelf layout state of the recommended books based on identification information about books included in the recommended books information in the state information.

In addition, the recommendation unit 140 may change a layout position of the recommended books to a predetermined position in the bookshelf based on the state information or changes the layout position of the recommended books to a layout position of the completely read books according to the state information to generate layout information and then transmit the generated layout information to the user apparatus 10 together with the recommended book information to induce the position of the recommended books to be changed to a position frequently selecting the books by the reader, thereby improving accessibility to recommended books of the reader and increasing reading efficiency of recommended books.

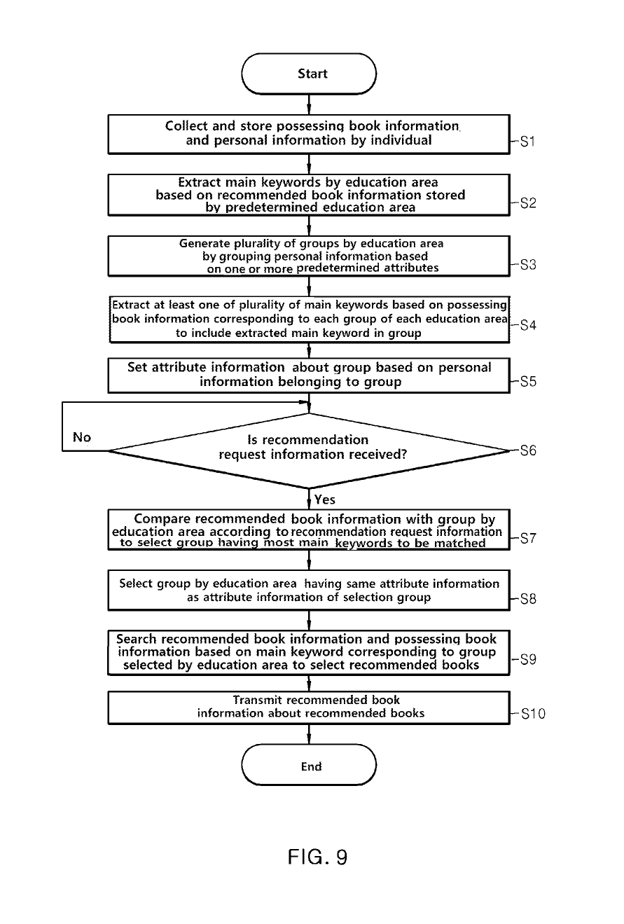

FIG. 9 is a flowchart for a method for providing a book recommendation service according to an embodiment of the present invention. As shown in FIG. 9, the apparatus 100 for providing the book recommendation service may collect possessing book information about one or more possessing books for each individual and personal information about a reader of the possessing books to match the collected possessing book information and personal information with each other and store the information in the member DB 103 (S1).

In addition, the apparatus 100 for providing the book recommendation service may extract a plurality of main keywords by the education area by applying weights to a redundancy frequency by keyword and a predetermined keyword based on the recommended book information about each of one or more recommended books stored by predetermined education area (S2).

Thereafter, the apparatus 100 for providing the book recommendation service may generate a plurality of groups by the education area by grouping the same personal information on the basis of one or more predetermined attributes (S3), extract at least one of the plurality of main keywords based on the possessing book information corresponding to each group of the education area to include the extracted keyword in the group (S4), and generate attribute information for each attribute based on the personal information belonging to the group to set the generated attribute information in the group (S5).

Meanwhile, the apparatus 100 for providing the book recommendation service compares the possessing book information corresponding to the recommendation request information with the group by education area when receiving the recommendation request information including the possessing book information from the user apparatus 10 (S6) to select a group having the most main keywords matched with the possessing book information included in the recommendation request information (S7).

Next, the apparatus 100 for providing the book recommendation service may select a group in which the same attribute information as the attribute information of the corresponding selection group is set by education area (S8), search possessing book information included in the recommended book information and the recommendation request information based on the main keyword corresponding to the group selected by education area to generate recommended book information about the recommended books selected by the education area (S9) and then transmit the generated recommended book information to the user apparatus 10 (S10).

Various apparatuses and components described in the present specification may be embodied by a hardware circuit (for example, a CMOS based logic circuit) , firmware, software, or combinations thereof. For example, the apparatuses and components may be embodied by using a transistor, a logic gate, and an electronic circuit in the forms of various electric structures.

The aforementioned contents can be corrected and modified by those skilled in the art without departing from the essential characteristics of the present invention. Accordingly, the various embodiments disclosed herein are not intended to limit the technical spirit but describe with the true scope and spirit being indicated by the following claims. The protection scope of the present invention should be construed based on the following appended claims and it should be appreciated that the technical spirit included within the scope equivalent to the claims belongs to the present invention.

What is claimed is:

1. An apparatus for providing a book recommendation service comprising:
a collection unit which collects possessing book information about one or more possessing books for each individual and personal information about a reader of the possessing books to match and store the information;
an extraction unit which extracts a plurality of main keywords by the education area by applying a weight to a redundancy frequency by keyword and each predetermined keyword based on recommended book information about each of one or more recommended books stored by predetermined education area;
a grouping unit which groups the same personal information based on one or more predetermined attributes to generate a plurality of groups by the education area, extracts at least one of the plurality of main keywords based on the possessing book information corresponding to each group of the education area to include the extracted keyword in the group, and generates attribute information about the attribute based on the personal information belonging to the group to set the generated attribute information in the group; and
a recommendation unit which selects the group having the most main keywords matched with the possessing book information of the user corresponding to recommendation request information when receiving the recommendation request information from a user apparatus, selects a group set with the same attribute information as the attribute information of the corresponding selection group by the education area, and searches possessing book information corresponding to the recommended book information and the recommendation request information based on the main keyword corresponding to the group selected by the education area to generate recommended book information about recommended books selected by the education area and then transmit the generated recommended book information to the user apparatus.

2. The apparatus for providing a book recommendation service of claim 1, wherein the grouping unit compares personal information collected by the collection unit by one or more predetermined attributes with each other to group personal information having the same parameters by all attributes into each other and generate a plurality of groups by the education area, compares the possessing book information matched with each personal information belonging to a specific group among the plurality of groups with the main keyword to include at least one of the plurality of main keywords belonging to the education area corresponding to the specific group as the group keyword in the specific group, and sets attribute information about attribute-specific parameters of the personal information belonging to the specific group as attributes of the group.

3. The apparatus for providing a book recommendation service of claim 2, wherein the grouping unit extracts a keyword having a redundancy frequency equal to or greater than a predetermined reference value which is calculated by comparison with each possessing book information corresponding to the specific group among the main keywords of the education area corresponding to the specific group as the group keyword to include the extracted keyword in the specific group.

4. The apparatus for providing a book recommendation service of claim 1, wherein the attribute includes at least one of age, gender, and area, and the grouping unit sets the attribute information about at least one of age, gender, and area as the group based on the plurality of personal information belonging to the group.

5. The apparatus for providing a book recommendation service of claim 1, wherein the possessing book information further includes completely read book information about books completely read by the reader among the possessing books, the grouping unit extracts the main keyword based on the completely read book information included in the possessing book information, and the recommendation unit selects the selection group based on the completely read book information included in the possessing book information according to the recommendation request information.

6. The apparatus for providing a book recommendation service of claim 5, wherein the recommendation request information further includes state information about a layout state of bookshelves by possessing books and completely read books according to the possessing book information, and
the recommendation unit confirms a layout state of the recommended book information and the completely read book information based on the state information and transmits layout information for changing a layout position of the recommended book information to a layout position of the completely read book information or changing the layout position of the recommended book information to a predetermined position in the bookshelf to the user apparatus.

7. A method for providing a book recommendation service in an apparatus for providing a book recommendation service communicating with an user apparatus via a communication network, the method comprising:
collecting possessing book information about one or more possessing books for each individual and personal information about a reader of the possessing books to match and store the information;
extracting a plurality of main keywords by the education area by applying a weight to a redundancy frequency by keyword and each predetermined keyword based on recommended book information about each of one or more recommended books stored by predetermined education area;
grouping the same personal information based on one or more predetermined attributes to generate a plurality of groups by the education area, extracting at least one of the plurality of main keywords based on the possessing book information corresponding to each group of the education area to include the extracted keyword in the group, and generating attribute information about the attribute based on the personal information belonging to the group to set the generated attribute information in the group; and
selecting the group having the most main keywords matched with the possessing book information of the user corresponding to recommendation request information when receiving the recommendation request information from a user apparatus, selecting a group set with the same attribute information as the attribute information of the corresponding selection group by the education area, and searching possessing book information corresponding to the recommended book information and the recommendation request information based on the main keyword corresponding to the group selected by the education area to generate recommended book information about recommended books selected by the education area and then transmit the generated recommended book information to the user apparatus.
